(19) United States
(12) Patent Application Publication
(10) Pub. No.: US 2005/0252380 A1
(43) Pub. Date: Nov. 17, 2005

(54) Method, device and installation for dehumidifying a structure such as a wall

(76) Inventors: Andre Gastaldi, Brunoy (FR); Thomas Gastaldi, Brunoy (FR)

Correspondence Address: YOUNG & THOMPSON, 745 SOUTH 23RD STREET, 2ND FLOOR, ARLINGTON, VA, 22202, US

(21) Appl. No.: 10/508,247

(22) PCT Filed: Mar. 19, 2003
(86) PCT No.: PCT/FR03/00882

§ 371 Date: Jun. 6, 2005

(30) Foreign Application Priority Data
Mar. 19, 2002 (FR) 02/03392

(51) Int. Cl. F26B 13/30; B01D 39/00

(52) U.S. Cl. 96/406; 34/92

(57) ABSTRACT

The device comprises a tube (1) with perforations (2), arranged in a blind hole (4) cut in a wall and supporting an inner concentric tube (7) with a solid wall. The space (9) between the two tubes is used to blow a current of air through, restricted at the inlet (11), undergoing a reduction in loading within the circuit, thus generating a depression which pumps humidity from the wall (5) and expels the same through the centre (10) of the tube (7). The above may be adapted to any thickness of wall by the provision of extensions (12).

The present invention relates to a method for removing the moisture from a structure such as a wall.

The present invention also relates to a device for implementing the method.

The present invention also relates to an installation comprising several such devices.

In the current state of the art, the devices called “wall dryers” use natural ventilation in perforated or porous tubes inserted in the walls in various positions and equipped with partitions for channelling this ventilation. The ventilation exists in theory but with limited and random effectiveness.

The object of the present invention is to remedy this drawback and in particular to greatly improve the drying effect obtained in the wall or other structure.

The idea on which the invention is based is to use a motive force to suck the moisture from the wall by a pumping action.

More particularly, according to a first aspect of the invention, the method for removing the moisture from a structure such as a wall, in which a hole formed in the structure is ventilated, is characterized in that a reduced air pressure is maintained in the hole.

By this reduced pressure, the moisture is sucked towards the hole, and then appears at the surface of the hole where it is converted into water vapour removed by the ventilation.

Preferably, said reduced pressure is established by means of a suction which at the same time serves to establish a current of air for said ventilation in the hole.

Thus, the suction action, which accelerates the progress of the water towards the surface of the hole, is combined with a significant reinforcement of the ventilation, which accelerates the evaporation of the moisture which appears at the surface of the hole.

Preferably the hole is connected to the outside of the hole via a narrow air-inlet passage. This narrow passage constitutes, in the path of the air, a pressure drop, downstream of which said reduced pressure appears under the action of said suction.

It is preferred according to the invention to place a filter between the surface of the hole and a source of said suction.

This filter has the task of preventing the sucked air from carrying towards the source, fragments which originate in the structure and can be dangerous for the suction source.

According to a second aspect of the invention the device for implementing the method according to the first aspect, comprising means for its mounting in a hole formed in the structure to be treated, is characterized in that it also comprises:
a suction tube having at least one suction orifice which in operation is situated inside the hole;
a suction source connected to the internal volume of the tube;
means for maintaining the tube in the hole with, between the periphery of the tube and the surface of the hole, a space which:
   a) communicates with the outside of the hole by a narrow inlet passage;
   b) is in a moisture exchange relationship with the wall of the hole;
   c) communicates with the suction orifice of the tube.

In a first embodiment of the invention the device comprises a perforated hollow body in the form of a pump strainer. This hollow body, preferably in the form of a perforated tube, fits into a blind hole made in the wall to be treated and is fixed there by sealing or by any other means. At its end turned towards the inside of the hole, this perforated tube includes a stopper to avoid direct suction without filtration through the strainer. The length of the perforated tube can be adapted to the thickness of the wall by means of one or more tubular extensions continuing the perforated tube towards the inside of the wall to be treated. In this case the stopper closes the free end of the last extension.

The perforated tube supports on its inside, by one or more ribs, a coaxial suction tube, smaller in diameter, so as to create a passage for a stream of air between the suction tube and the outer perforated tube. The suction tube projects outside the hole and beyond the outer tube, and has in this area a part shaped like a mushroom cap, turned-back towards the wall to be treated, in order to define with the wall a narrow passage allowing the entry of the air stream while slowing and channelling the latter. At its other end, turned towards the inside of the blind hole, the suction tube ends a few millimetres short of the stopper of the strainer, in order to allow the stream of air arriving via the gap between the two tubes the possibility of going round the edge of the suction tube in order to flow-back towards the outside of the hole via the inner space of the suction tube.

The suction tube is linked to a suction source which can be a coupling intended to communicate with an external suction device, or can be an integrated suction device, such as a small motorized turbine. According to its design, the motor can be fed by a local photogenerator, a cell, a battery, a hydraulic, pneumatic or other means. The suction prevailing in the suction tube creates, by the pressure drop accentuated by the slowing of the air at the inlet, a reduced pressure between the two concentric tubes, which causes an effective and rapid pumping of the moisture from the wall through the perforations or pores of the strainer.

In another embodiment, the surface of the hole made in the structure to be treated is exposed and directly delimits the water-pumping space. In this case, the filtration function, if it is necessary, is carried out by a filter which the air must pass through in order to reach the inside of the suction tube.

In one or other version there can advantageously be provided, for example inside the suction tube, a moisture detector and means for controlling the operation and stopping of the suction source as a function of a measured degree of humidity. Typically, when the measured degree of humidity falls below a low threshold, the suction source is stopped. When the degree of humidity rises above a high threshold, the suction source is put into operation.

According to a third aspect of the invention, an installation is proposed, comprising several devices according to the second aspect, in which the suction source is constituted by suction couplings connected to a common suction unit.

Other features and advantages of the invention will also appear from the description below, which relates to non-limitative examples.

In the attached drawings:

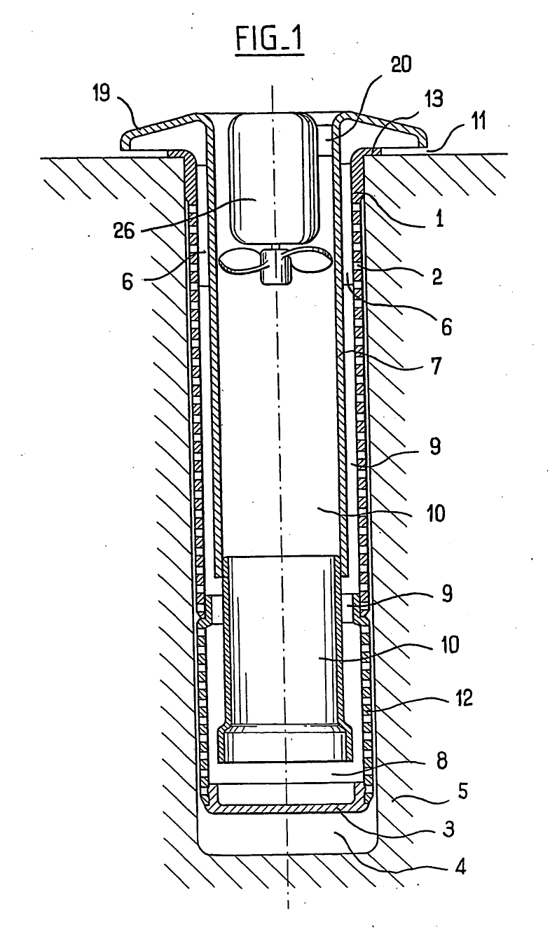

FIG. 1 is a sectional view of a first embodiment of the device according to the invention, with integrated suction source;

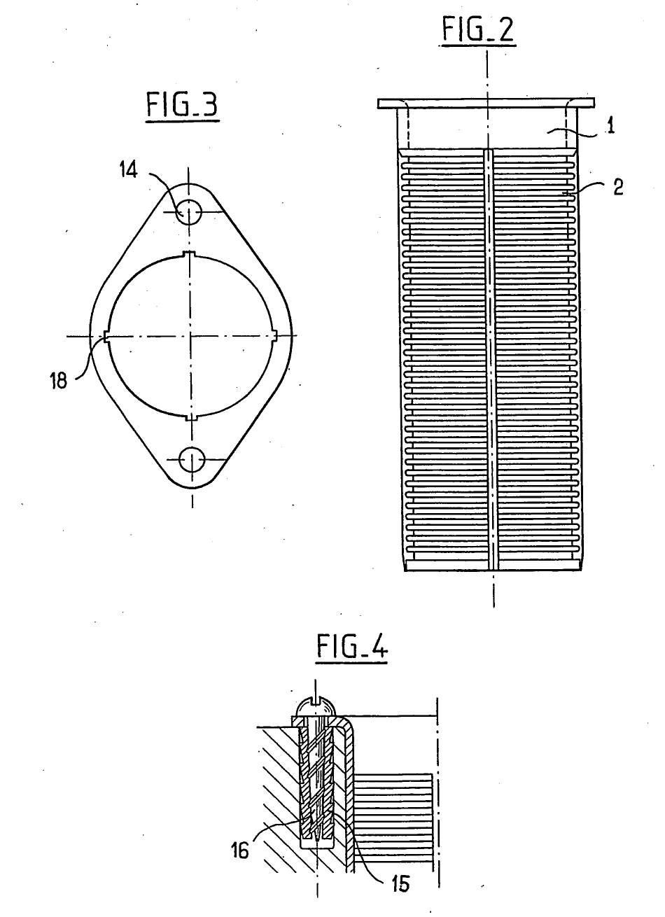

FIG. 2 shows the strainer of the device of FIG. 1, produced by injection of a thermoplastic;

FIG. 3 is a view from the left of the strainer of FIG. 2;

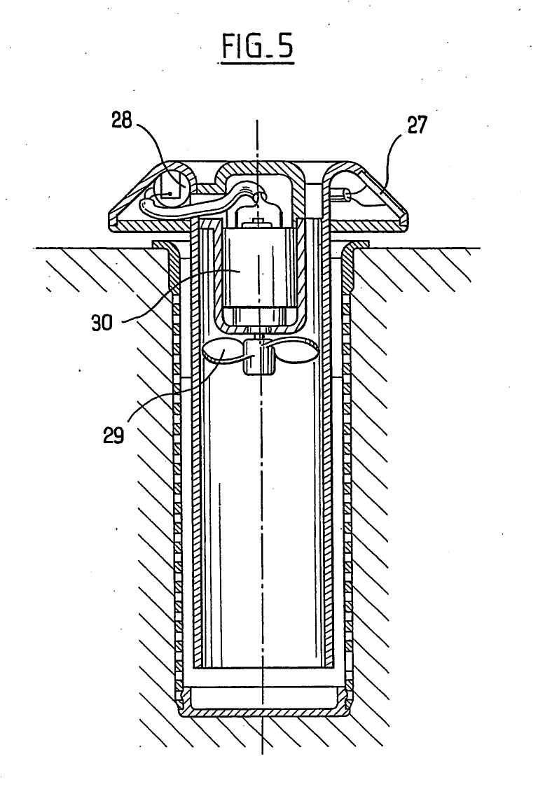

FIG. 4 is a sectional part-view illustrating an example for securing the strainer to a wall;

FIG. 5 is a view similar to FIG. 1, but representing a second embodiment of the device, which is equipped with a photogenerator;

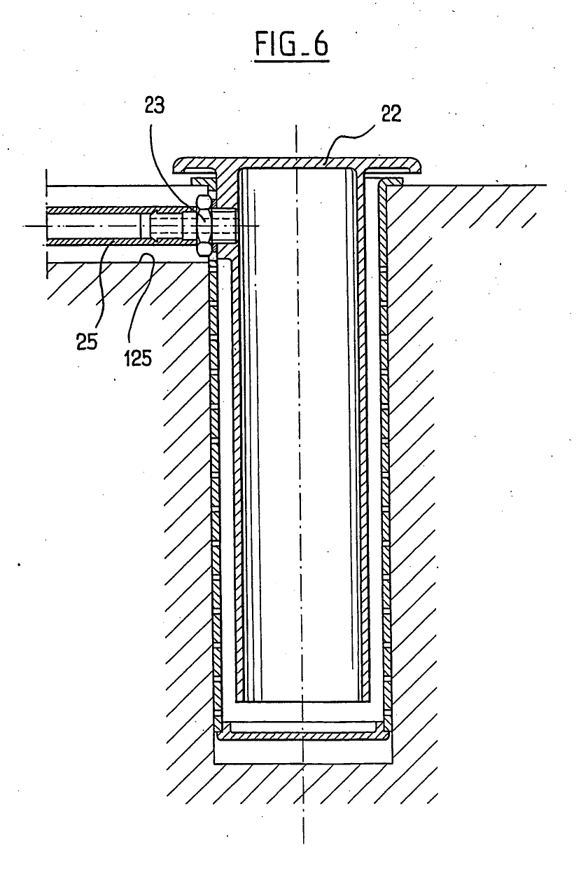

FIG. 6 is a view similar to FIG. 1, but showing a third embodiment of the device, designed to be installed in a network;

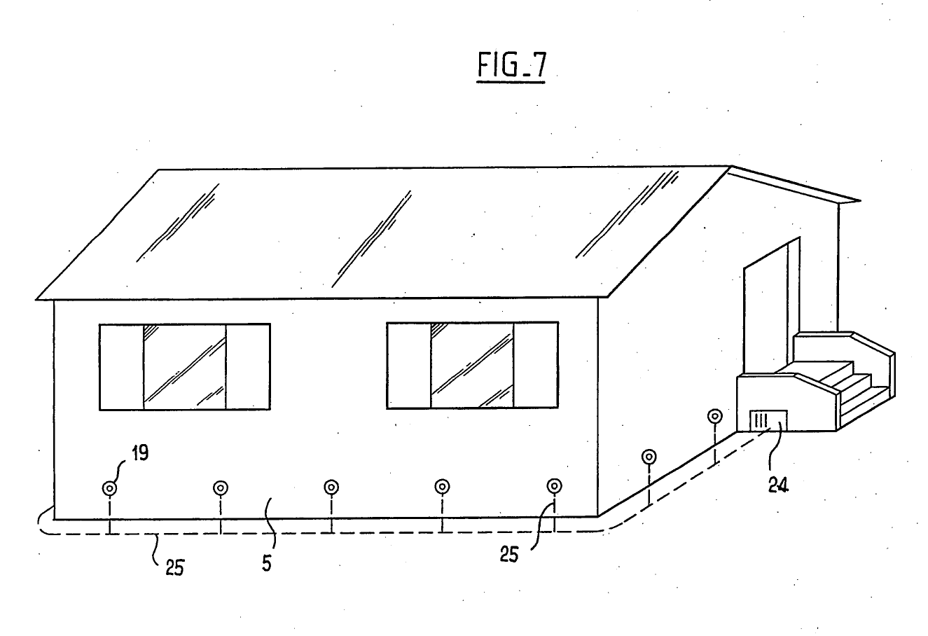

FIG. 7 diagrammatically shows the installation in a network according to the invention;

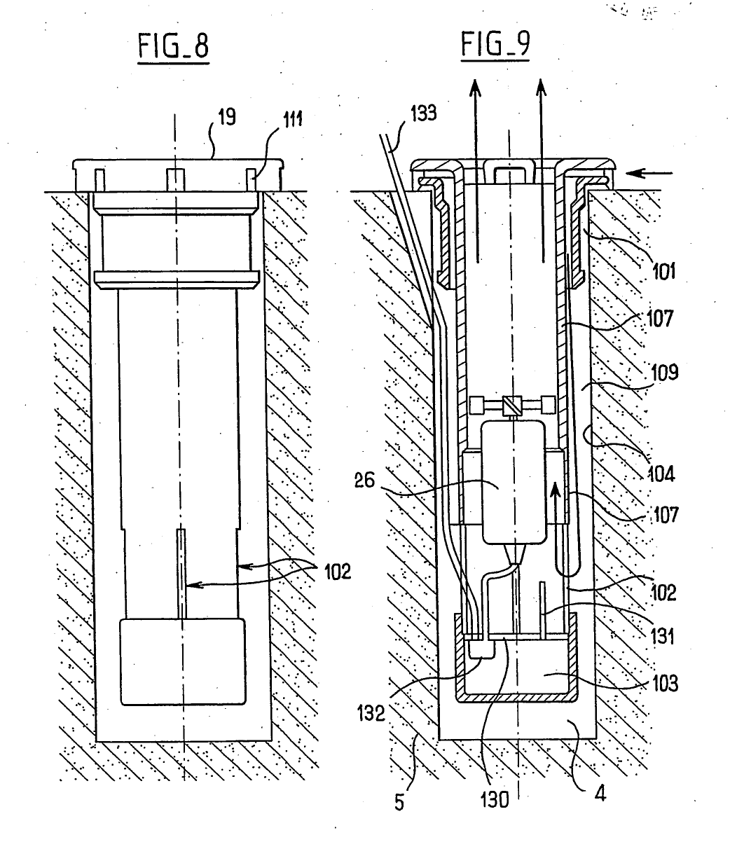

FIG. 8 is an elevational view of a fourth embodiment of the device according to the invention; and

FIG. 9 is an axial section view of the fourth embodiment.

As FIG. 1 shows, a blind hole 4 has been made in the wall 5 or other structure to be treated, and more particularly to be dehumidified or dried. In the blind hole 4, a device has been placed comprising an outer tube 1 which is inserted into the orifice of the blind hole. The outer tube 1 has a radially outwardly directed rim 13, which is placed resting against the outer surface of the structure around the orifice of the blind hole. The rim 13 forms a flange for securing the tube 1 and more generally the device, by means of two through-holes 14 (FIG. 3), intended to receive fixing screws 16 (FIG. 4) co-operating with expanding plugs 15 inserted in holes bored in the wall.

Opposite the rim 13 (FIG. 1) the tube is continued by a tubular strainer having perforations 2 and closed by a stopper 3 at the end opposite the rim 13, thus turned towards the inside of the hole 4. In the example represented, the strainer is formed by a proximal part which is all in one piece with the tube 1, and by a tubular extension 12 interposed between the proximal part and the stopper 3 in order to adapt the length of the device to the depth of the hole 4, itself chosen in relation to the thickness of the wall 5 or other structure mass to be treated.

The device also comprises a suction tube 7 which is placed coaxially inside the tube 1, the strainer which continues it, and the extension 12. The tube 7 is itself composed of a main tube continued towards the inside of the blind hole 4 by an extension, the axial length of which is equal to that of the extension 12 of the strainer.

The external diameter of the suction tube 7 is smaller than the internal diameter of the outer tube 1 and the strainer. For securing the suction tube 7 in the tube 1, the latter contains four axial internal grooves 18 into which external axial ribs 6 of the suction tube 7 are fitted, with securing by gluing, snap-locking or any other means.

Outside the wall 5 the suction tube 7 forms a projection in the shape of a mushroom cap 19, the edge of which, turned towards the wall, defines with the latter a narrow passage 11 allowing air coming from the outside to enter the annular channel 9 formed between the two tubes 1, 7.

At its end turned towards the bottom of the blind hole 4, the suction tube 7 ends at a distance 8 from the stopper 3 that is more or less equal to the distance almost constant along the axis, made between the inside of the strainer and the outside of the suction tube 7.

A motorized turbine 26 is secured in the inner space 10 of the suction tube 7 by means of one or more ribs 20. The turbine 26 is mounted so as to suck in air coming from the inside of the blind hole 4 and deliver this air to the outside through an orifice provided in the centre of the mushroom-shaped projection 19.

Thus, when the device is mounted in the blind hole 4 and the motorized turbine is in operation, air is sucked through the narrow passage 11, travels towards the bottom of the cavity 4 between the two tubes 1, 7, goes round the distal end of the suction tube 7 or respectively the last extension which continues it, and then heads for the outside of the hole 4 through the suction tube 7. The flow of air slowed by the narrow passage 11 and the pressure drops in the passage 9 between the two tubes is at a reduced pressure in said passage 9. This reduced pressure pumps the moisture from the wall 5 through the perforations 2 of the strainer and its optional extensions 12. This moisture evaporates in the flow of air or forms a mist therein and it is thus removed through the external orifice of the suction tube 7 with the discharge of the motorized turbine 26.

The strainer serves as a filter allowing the moisture to seep from the surface of the blind hole 4 whilst preventing the flow of air from carrying towards the motorized turbine 26, fragments of wall of a greater size than the perforations 2.

In the embodiment of FIG. 5, a photogenerator 27 feeds a battery-regulating unit 28. The regulator then authorizes the rotation of the propeller 29 driven by the electric motor 30 of the motorized turbine until the next charging cycle.

In another embodiment, represented in FIG. 6, the device is simplified in order to be used in a network. To this end, the suction turbine 26 of the previous examples is omitted and a wall 22 closes off the proximal end of the suction tube. The suction source is constituted by a trade coupling 23 screwed into the suction tube perpendicular to its axis and on which a duct 25 connecting to a suction unit is mounted. The duct 25 is preferably concealed in a groove in the wall, which groove 125 can then be resealed with a suitable cement.

FIG. 7 represents an installation according to the invention, comprising several devices according to FIG. 6, the ducts 25 of which are connected to a common unit 24. The installation can be equipped with a moisture sensor which can be connected to a home automation system which manages the hygrometric state of the wall.

As the expelled moist air is channelled, it is possible to envisage using the device inside the building in order to dry damp rooms or wine cellars for example. The removal by suction of the ambient air causes a ventilation which accelerates the rehabilitation of the premises.

The example of FIGS. 8 and 9 will be described only where it differs from that of FIG. 1. The outer tube 101 is now no more than a short tube for mounting the device by inserting this tube 101 into the orifice of the blind hole 4. The surface 104 of the hole 4 is exposed in order to delimit on the radially outer side the space or channel 109 in which the air travels before entering the suction tube 107.

The strainer 102 ending in its stopper 103 henceforth constitutes the distal region of the suction tube 107, upstream of the motorized turbine 26. In the example represented, the strainer is realized in the form of axial slits which are made in the tube 107 and the width of which defines the maximum size of the particles allowed to reach the motorized turbine 26.

The special features which have just been described for this embodiment have the advantage of simplifying the manufacture of the device and making it more economical, and at the same time improving on the one hand the application of the reduced pressure to the surface 104 of the blind hole 4, and on the other hand making the stream of air more effective for carrying along the water which seeps through the surface 104.

According to another development of this embodiment there is in the suction tube 107, upstream of the motorized turbine 26, a printed circuit board 130 which carries a moisture sensor 131 and a means 132 for starting and stopping the motorized turbine 26. Control means also carried by the board 130 are sensitive to the hygrometry of the air passing through the strainer 102 into the suction tube 107 in order to control the starting-up of the motorized turbine 26 when the hygrometry, as measured by the sensor 131, exceeds a high threshold, and the stopping of the motorized turbine when the hygrometry falls below a low threshold. The board 130 is fed by wires 133 connected to an external source, not represented.

According to a third modification represented in FIGS. 8 and 9, the inlet passage 11 is no longer constituted by a continuous slit but by notches formed in the turned-back edge of the mushroom 19 which apart from the notches is now in contact with the surface of the wall 5 around the orifice of the blind hole 4.

Of course, the invention is not limited to the examples described and represented.

In particular, each of the three modifications described in relation to FIGS. 8 and 9 is applicable independently of the other two in each of the embodiments described above.

1. A method for removing the moisture from a structure (5) such as a wall, in which a hole (4) formed in the structure is ventilated, characterized in that a reduced air pressure is maintained in the hole (4).

2. A method according to claim 1, characterized in that said reduced pressure is established by means of a suction which at the same time serves to establish a current of air for said ventilation in the hole (4).

3. A method according to claim 2, characterized in that the hole is connected to the outside of the hole via a narrow air-inlet passage (11, 111).

4. A method according to claim 2, characterized in that a filter (2, 102) is placed between the wall of the hole (4) and a source (26, 23) of said suction.

5. A device for implementing a method according to claim 1, comprising means (1) for mounting said device in a hole (4) formed in the structure (5) to be treated, and characterized in that it also comprises:
a suction tube (7, 107) having at least one suction orifice which in operation is located inside the hole (4);
a suction source (23, 26) connected to the internal volume (10) of the suction tube;
means (1, 101) for maintaining the tube (7) in the hole (5) with, between the periphery of the tube (7) and the surface (104) of the hole, a space (9, 109) which:
a) communicates with the outside of the hole (4) by a narrow inlet passage (11, 111);
b) is in a moisture exchange relationship with the wall (104) of the hole (4);
c) communicates with the suction orifice of the tube (7, 107).

6. A device according to claim 5, characterized in that the mounting means comprise an outer tube (1, 101) which is fixed in the orifice of the hole (4) and which supports the suction tube (7, 107) while providing an air passage (9) between the two tubes.

7. A device according to claim 5, characterized by a filtration means (2, 102) interposed between the surface (104) of the hole (4) and the suction orifice of the suction tube (7, 107).

8. A device according to claim 7, characterized in that the filtration means (102) is placed at the suction orifice of the suction tube (107).

9. A device according to claim 5, characterized in that the water-pumping space (109) communicates directly with the surface (104) of the hole (4), said surface bounding, as an exposed surface, said space (109) over a large part of its extent.

10. A device according to claim 6, characterized in that the outer tube (1) is continued by a filtration strainer interposed between the surface of the hole (4) and the suction orifice of the suction tube (7).

11. A device according to claim 5, characterized in that the suction tube (7, 107) forms on the outside of the structure a projection shaped like a mushroom cap (19), the edge of which, turned towards the structure, forms with the latter said narrow inlet passage (11, 111).

12. A device according to claim 5, characterized in that it comprises a moisture detector (131), and means (132) for controlling operation and stopping of the suction source (26) as a function of the measured degree of humidity.

13. A device according to claim 5, characterized in that the suction source is a suction coupling (23) starting from the tube (7, 107) downstream of at least one suction orifice.

14. A device according to claim 5, characterized in that the suction source is a motorized turbine (26) mounted in the tube (7, 107) downstream of at least one suction orifice.

15. A device according to claim 14, characterized in that the turbine (26) is fed from an integrated photogenerator (27).
